(19) United States
(12) Patent Application Publication
(10) Pub. No.: US 2013/0295513 A1
(43) Pub. Date: Nov. 7, 2013

(54) Susceptor For Directional Solidification Furnace

(71) Applicant: Lee William Ferry, St. Charles, MO (US)

(72) Inventor: Lee William Ferry, St. Charles, MO (US)

(73) Assignee: MEMC SINGAPORE PTE. LTD. (UEN200614794D), Singapore (SG)

(21) Appl. No.: 13/464,290

(22) Filed: May 4, 2012

(51) Int. Cl. F27D 5/00

(52) U.S. Cl. 432/253

(57) ABSTRACT

A susceptor supports a crucible in a furnace and includes a first wall having a vertical edge and a second wall having a vertical edge. A first interlocking member is on the vertical edge of the first wall and a second interlocking member is on the vertical edge of the second wall. The first interlocking member is interlocked with the second interlocking member when the first wall and second wall are in an assembled configuration. Openings are disposed through the first interlocking member and the second interlocking member. Each of the openings through the first interlocking member is coaxial with each of the openings through the second interlocking member.

### FIELD

This disclosure generally relates to directional solidification furnaces and, more specifically, to susceptors for directional solidification furnaces.

### BACKGROUND

Directional solidification furnaces are used to produce multi-crystalline silicon ingots. During use of the furnace, raw silicon is first placed into a crucible disposed in the furnace. The raw silicon can take the form of solid chunks, recycled polysilicon, silicon dust, or a combination thereof. The crucible is typically constructed of quartz or another suitable material that can withstand high temperatures. The crucible is a five-sided box, with a lid placed over an open top of the box. The crucible is supported by a susceptor that adds structural support and rigidity to the crucible. The susceptor usually comprises four vertical walls connected by fastening systems (e.g., nuts and bolts) and positioned atop a bottom.

The crucible and susceptor are disposed within a containment vessel that forms part of the furnace. The containment vessel seals the crucible from the outside ambient environment. The crucible and the charge are then heated to a temperature sufficient to melt the silicon. After the charge has completely melted, it is cooled at a controlled rate to achieve a directional solidification structure within the resulting ingot.

A concern in the production of multi-crystalline ingots is the strength and ease of assembly and disassembly of the susceptor. The fastening systems used in known susceptors to connect the vertical walls to each other may lack sufficient strength to prevent the walls from separating during a failure of the integrity of the crucible. Moreover, the known fastening systems are often difficult to assemble and do not permit ready disassembly of the walls of the susceptor.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

One aspect of the present disclosure is a susceptor for supporting a crucible in a directional solidification furnace used to melt a semiconductor material. The susceptor includes four walls and each wall has a vertical edge. An interlocking member is on each edge. The interlocking member of one wall is interlocked with the interlocking member of an adjacent wall at a corner of the susceptor. Openings are disposed through the interlocking members. The openings in the interlocking member of one wall are coaxial with the openings in the interlocking member of the adjacent wall. At least four rods are provided and each rod is disposed in the openings of the interlocking members of one of the corners of the susceptor.

Another aspect of the present disclosure is a susceptor for supporting a crucible in a furnace. The susceptor includes a first wall having a vertical edge and a second wall having a vertical edge. A first interlocking member is on the vertical edge of the first wall and a second interlocking member is on the vertical edge of the second wall. The first interlocking member is interlocked with the second interlocking member when the first wall and second wall are in an assembled configuration. Openings are disposed through the first interlocking member and the second interlocking member. Each of the openings through the first interlocking member is coaxial with each of the openings through the second interlocking member.

Yet another aspect of the present disclosure is a susceptor for supporting a crucible in a directional solidification furnace used to melt a semiconductor material. The susceptor includes a first wall having a vertical edge and an interior surface and a second wall having a vertical edge and an interior surface. When in an assembled configuration, the vertical edge of the first wall is positioned adjacent a portion of the interior surface of the second wall. A separator is positioned between the vertical edge of the first wall and the portion of the interior surface of the second wall. The separator prevents contact between the vertical edge of the first and the portion of the interior surface of the second wall when the walls are in the assembled configuration.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a schematic view of an example directional solidification furnace

FIG. 2 is a perspective view of assembled walls of an example susceptor;

FIG. 3 is a partially exploded view of the susceptor of FIG. 2;

FIG. 4 is an enlarged view of a portion of FIG. 3;

FIG. 5 is an enlarged view of a portion of FIG. 4;

FIG. 6 is a perspective view of another example susceptor; and

FIG. 7 is an enlarged portion of FIG. 5, with portions omitted for clarity.

Like reference symbols in the various drawings indicate like elements.

### DETAILED DESCRIPTION

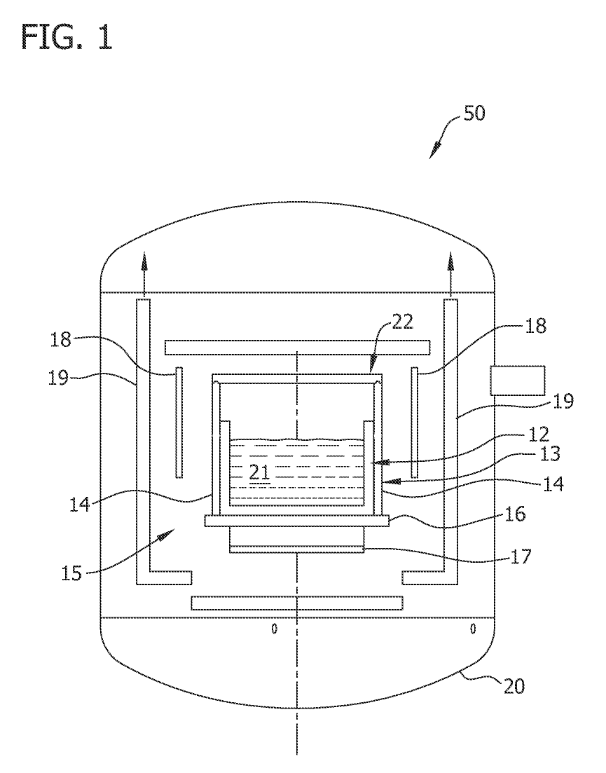

The embodiments described herein generally relate to susceptors for supporting a crucible in a directional solidification furnace. An example furnace is shown schematically in FIG. 1 and indicated generally at 50. Directional solidification furnaces are described in greater detail, for example, in U.S. patent application Ser. No. 12/563,124, filed Sep. 19, 2009, the entire disclosure of which is hereby incorporated by reference. The furnace may be used for the production of multi-crystalline silicon, for example, which may be used in the fabrication of photovoltaic modules, e.g., for producing electricity. This furnace is merely one example, and other furnaces and other materials may be produced therein in accordance with this disclosure.

The example directional solidification furnace 50 comprises a quartz crucible 12 supported by a crucible support 13 (i.e., a susceptor), including walls 14 and a crucible base 16. Together with a lid 22, the crucible 12, walls 14 and crucible base 16 form a crucible assembly or an inner assembly 15. This inner assembly 15 may also include a heat exchanger 17 disposed beneath the crucible base 16. A lid 22 is positioned atop the crucible 12.

Heaters 18 are suitably positioned around the walls 14 and within a containment vessel 20. The heaters 18 may also be disposed above the crucible 12, and the heaters may suitably be radiant heaters. The heaters 18 apply the heat necessary to melt charge material within the crucible 12. The charge material of this embodiment is silicon, though other materials are contemplated. Side insulation 19 is disposed around the crucible 12 and may be partially opened, such as by vertical movement (shown by arrows in FIG. 1). Once the silicon charge has melted, a cooling medium may be introduced to the heat exchanger 17 or the insulation 19 may be raised to aid in the directional solidification of the silicon. The heat output of the heaters 18 may be adjusted so that less heat is applied to the melt 21. The position of the heaters 18 may also be adjusted relative to the crucible by moving them away from the crucible 12, especially away from the crucible base 16. Directional solidification of the ingot may then be achieved. Typically, the portion of the melt 21 nearest the crucible base 16 solidifies first and the solidification proceeds in a general upward fashion away from the crucible support base 16. The last portion to solidify is the top surface of the melt 21.

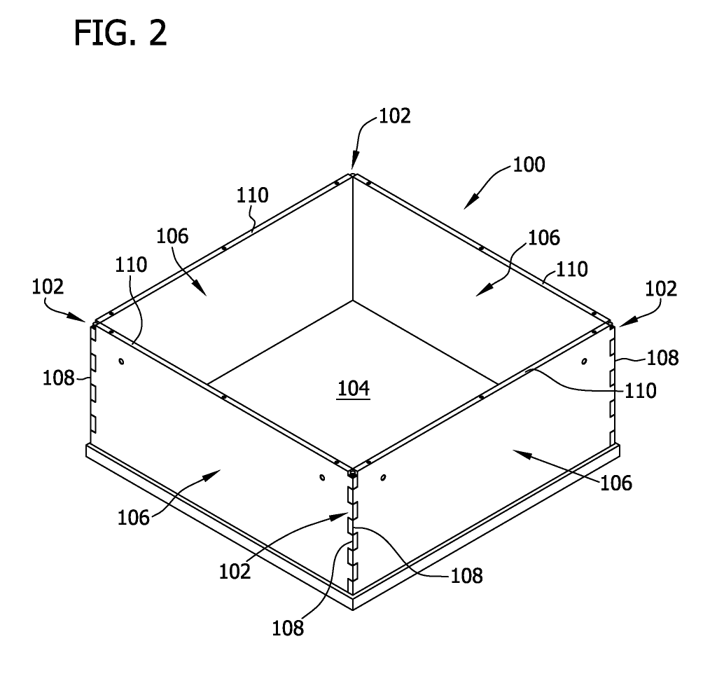

Referring now to FIG. 2, a susceptor is indicated generally at 100 which is similar to the support 13 described above. A crucible may be positioned within an interior of the susceptor 100 in use, but is omitted for clarity. Heaters and other structures shown in FIG. 1 are also omitted for clarity from FIG. 2 and the remaining Figures. The susceptor 100 in this embodiment has four corners 102 and a bottom 104 and is of a generally square or rectangular shape. In other embodiments the susceptor 100 may have other shapes.

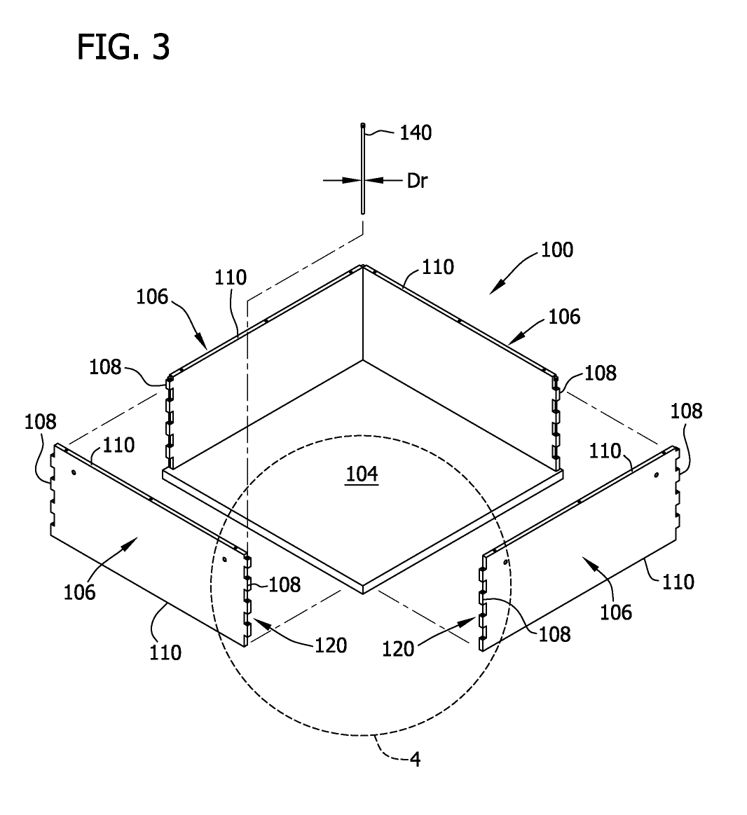

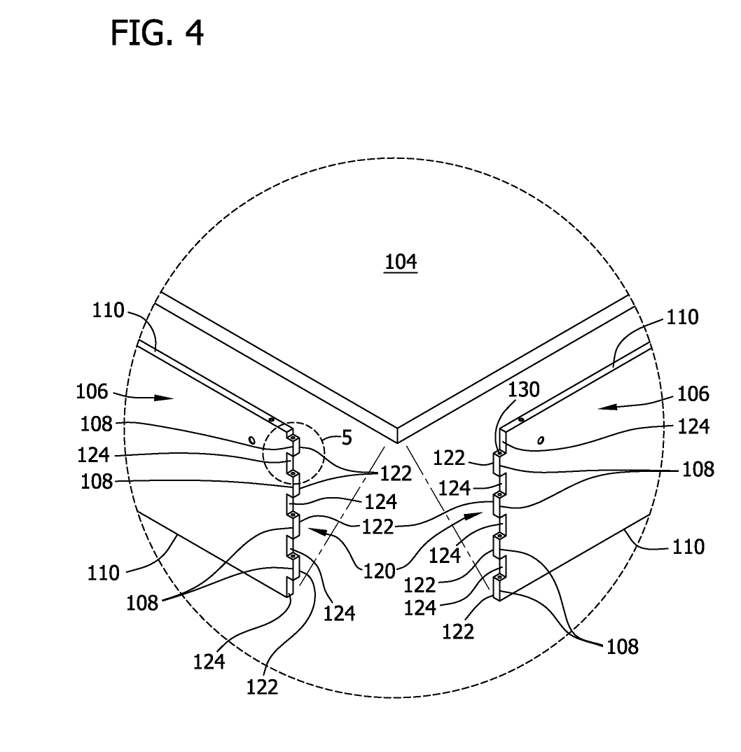

The susceptor 100 has four vertical walls 106 (two of which are shown in the view of FIG. 3) connected together. In other embodiments, the susceptor 100 may have a different number of walls 106. Each of the walls 106 has a pair of vertical edges 108, as more clearly shown in FIGS. 3 and 4, and a pair of horizontal edges 110. The walls 106 may be made of any suitable high-temperature or temperature-resistant material, such as carbon fiber, carbon fiber composite, graphite, or a combination thereof.

An interlocking member (generally referred to as 120 and shown in FIGS. 3 and 4) is disposed on each of the vertical edges 108 of the walls 106. When the walls 106 are in an assembled configuration as shown in FIG. 2, the interlocking member 120 of one wall is interlocked with the interlocking member of an adjacent wall at one of the corners 102 of the susceptor 100.

Each of the interlocking members 120 comprises tenons 122 and mortises 124 positioned between the tenons. As shown, the number of mortises 124 in the interlocking member 120 of one wall 106 is equal to the number of tenons 122 of the interlocking member of the adjacent wall. That is, the interlocking members 120 disposed on the vertical edges 108 of adjacent walls 106 have equal numbers of mortises 124 and tenons 122. In other embodiments, different types of interlocking members 120 may be used other than or in addition to the interlocking members to interlock the walls 106 of the susceptor 100, such as dovetail grooves.

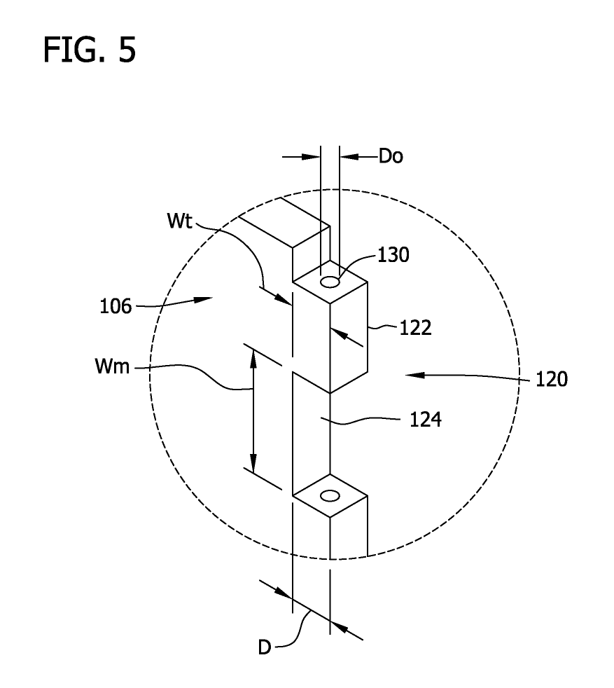

As shown in FIG. 5, the mortises 124 of the interlocking members 120 have a width Wm and the tenons 122 have a width Wt. The width Wm of the mortises 124 is greater than the width Wt of the tenons 122 in this embodiment to permit the tenons to be received with the mortises. Thus the tenons 122 of the interlocking member 120 of one wall 106 are received within the mortises 124 of the adjacent wall when the two walls are interlocked. Moreover, in some embodiments, the width Wm of the mortises 124 may be equal to or slightly less than the width Wt of the tenons 122 such that the two have an interference-type fit when interlocked.

The tenons 122 of the interlocking members 120 have a thickness T and the mortises 124 have a depth D. In this embodiment, the depth D of the mortises 124 is equal to the thickness T of the tenons 122. However, in other embodiments the thickness T and depth D may differ by some amount.

In this embodiment, openings 130 are disposed through the interlocking members 120, as best shown in FIGS. 4 and 5. The openings 130 through the interlocking member 120 of one wall 106 are coaxial with the openings through the interlocking member of the adjacent wall the two are interlocked. In this embodiment, the openings 130 are disposed in the tenons 122 of each interlocking member 120. Each opening 130 is coaxial with the other openings in other tenons 122 of the same interlocking member 120. Further, each opening 130 is also coaxial with other openings in the tenons 122 of the interlocking member 120 in the adjacent wall 106 when the two walls are interlocked.

Rods 140 (one of which is shown in FIG. 3) are disposed in the openings 130 in the interlocking members 120 in the corners 102 of the susceptor 100 when the walls 106 are interlocked. The rods 140 thus function to secure adjacent walls together in an interlocked configuration. In this embodiment, one rod 140 is disposed in each corner 102 of the susceptor 100 when the walls 106 are interlocked, and thus four rods are used. Other susceptors (e.g., those having a different number of walls and/or corners) may use different numbers of rods 140. The rods 140 are suitably made of any high-temperature material, such as carbon fiber composite, molybdenum or other refractory metals, graphite, and ceramic materials.

The rods 140 have a diameter Dr that is less than a diameter Do of the openings 130 such that the rods may pass through the openings. In one embodiment, the diameter Dr is about 7.5 mm, and the diameter Do is about 9.0 mm, so that Dr is about 1.5 mm less than the diameter Do. The rods 140 may be secured in their position shown in FIG. 2 by any suitable type of fastening system. For example, the rods 140 may be bolts and a nut may be used to secure the rod and prevent its longitudinal movement within the openings 130.

In operation, the susceptor 100 is assembled by positioning walls 106 adjacent each other such that the tenons 122 of one interlocking member 120 are positioned within the mortises 124 of the interlocking member of the adjacent wall, and vice versa. The rod 140 is then inserted through the openings 130 to secure the walls 106 in the interlocked configuration. A fastening system may be used to secure the rod 140. The process is then repeated for each of the walls 106 in the susceptor 100 until all of the walls are interlocked with their respective adjacent walls.

The susceptor 100 of the embodiment of FIGS. 1-5 presents several advantages over other known susceptors. For example, the rods 140 and the connection of the walls 106 using the rods and interlocking members 120 significantly increases the strength of the corners 102 of the susceptor 100 and the susceptor in general. Thus, the susceptor 100 is better able to function as a barrier to molten silicon leaking into the furnace in the event of a failure of the crucible. Also, the stronger susceptor 100 is better able to withstand the radial forces produced by the solidifying ingot. Moreover, the susceptor 100 is also able to be readily separated and disassembled. For example, the susceptor 100 may be disassembled after the run, so that the solidified ingot can be removed for processing.

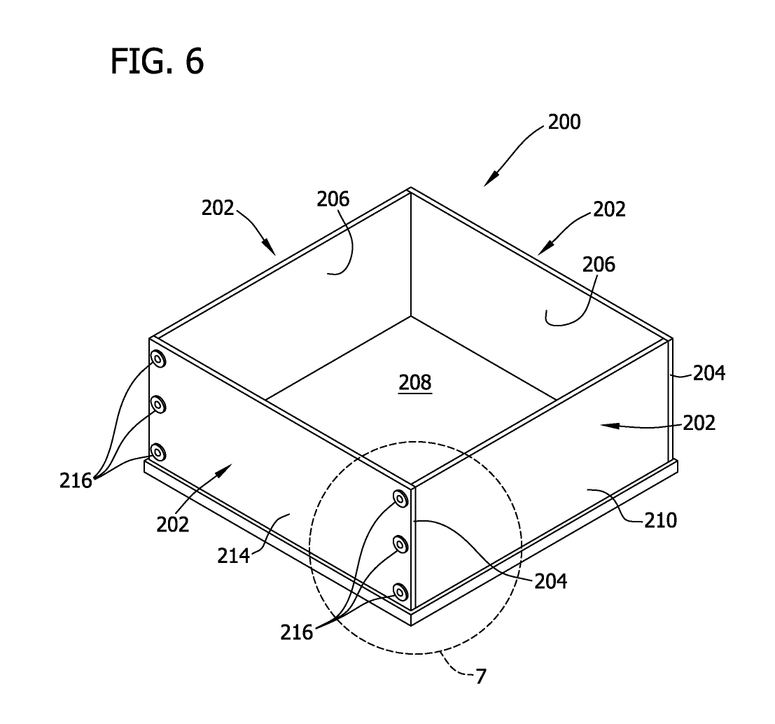

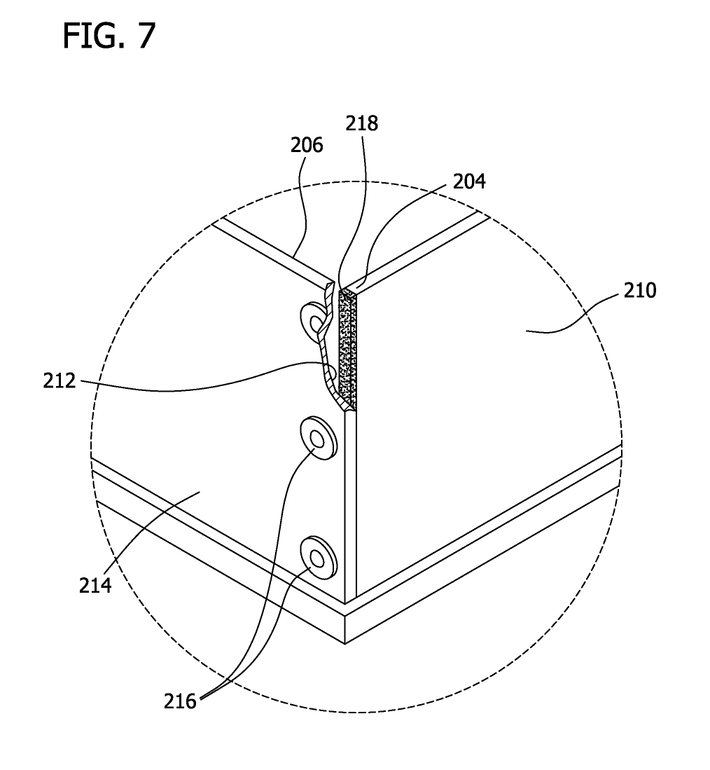

FIGS. 6 and 7 depict another embodiment of a susceptor 200 similar to the susceptor described above. In the embodiment of FIGS. 6 and 7, the susceptor 200 includes four walls 202 (two of which are identified specifically as a first wall 210 and a second wall 214), each of which has a vertical edge 204 and an interior surface 206, and a bottom 208. As shown in FIG. 6, in an assembled configuration, the vertical edge 204 of the first wall 210 is positioned adjacent a portion 212 of the interior surface 206 of the adjacent, second wall 214. A fastening system 216 (e.g., nuts and bolts) is used to secure the walls in the assembled configuration.

As shown in FIG. 7, a separator 218 is positioned between the vertical edge 204 of the first wall 210 and the portion 212 of the interior surface 206 of the second wall 214. The separator 218 is positioned adjacent the vertical edge 204 of the first wall 210 or the portion 212 of the interior surface 206 of the second wall 214. This positioning may occur prior to or during assembly of the susceptor 200.

The separator 218 prevents or inhibits contact between the vertical edge 204 of the first wall 210 and the portion 212 of the interior surface 206 of the second wall 214 when the walls are in the assembled configuration. Thus the separator 218 prevents the vertical edge 204 of the first wall 210 from bonding to the portion 212 of the interior surface 206 of the second wall 214, e.g., during operation of the susceptor 200.

The separator 218 may be made of any suitable material, such as a fabric made of compressed fibers. One example of such a fabric is felt.

In prior systems lacking a separator, the contact between the walls or portions thereof (e.g., the vertical edge and portion of the interior surface) may have resulted in the two becoming bonded together when the susceptor was subject to elevated temperatures during use of the furnace. Such bonding made disassembly of the susceptor difficult, if not impossible.

While the invention has been described in terms of various specific embodiments, it will be recognized that the invention can be practiced with modification within the spirit and scope of the claims.

When introducing elements of the present disclosure or the embodiments thereof, the articles “a”, “an”, “the” and “said” are intended to mean that there are one or more of the elements. The terms “comprising”, “including” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A susceptor for supporting a crucible in a directional solidification furnace used to melt a semiconductor material, the susceptor comprising:
four walls, each wall having a vertical edge;
an interlocking member on each edge, wherein the interlocking member of one wall is interlocked with the interlocking member of an adjacent wall at a corner of the susceptor;
openings through the interlocking members, wherein the openings in the interlocking member of one wall are coaxial with the openings through the interlocking member of the adjacent wall; and
at least four rods, each rod being disposed in the openings of the interlocking members of one of the corners of the susceptor.

2. The susceptor of claim 1, wherein each of the interlocking members comprises tenons and mortises positioned between the tenons.

3. The susceptor of claim 2, wherein the openings extend through the tenons of each interlocking member.

4. The susceptor of claim 1, wherein the openings have
a diameter and the rods have a diameter, and wherein the diameter of the openings is greater than the diameter of the rods.

5. The susceptor of claim 2, wherein the mortises of the interlocking member of one wall are equal in number to the tenons of the interlocking member of the adjacent wall.

6. The susceptor of claim 2, wherein the mortises of the interlocking members have a width and the tenons of the interlocking members have a width, wherein the width of the mortises is greater than or equal to the width of the tenons, wherein the mortises have a depth and the tenons have a thickness, and wherein the depth of the mortises is equal to the thickness of the tenons.

7. The susceptor of claim 6, wherein the tenons of the interlocking member of one wall are received within the mortises of the adjacent wall when the two walls are interlocked.

8. The susceptor of claim 1, wherein the walls comprise at least one of carbon fiber composite or graphite.

9. The susceptor of claim 1, wherein the rods comprise at least one of molybdenum, carbon fiber composite, graphite, ceramic materials, and stainless steel.

10. A susceptor for supporting a crucible in a furnace, the susceptor comprising:
a first wall having a vertical edge;
a second wall having a vertical edge;
a first interlocking member on the vertical edge of the first wall;
a second interlocking member on the vertical edge of the second wall, wherein the first interlocking member is interlocked with the second interlocking member when the first wall and second wall are in an assembled configuration; and
openings through the first interlocking member and the second interlocking member, wherein each of the openings through the first interlocking member is coaxial with each of the openings through the second interlocking member.

11. The susceptor of claim 10, further comprising a rod, and wherein the rod is disposed in the openings in the first interlocking member and the second interlocking member when the first and second wall are in the assembled configuration.

12. The susceptor of claim 10, wherein the first interlocking member and the second interlocking member each comprise tenons and mortises positioned between the tenons.

13. The susceptor of claim 12, wherein the mortises of the first interlocking member are equal in number to the tenons of the second interlocking member, and wherein the tenons of the first interlocking member are equal in number to the mortises of the second interlocking member.

14. The susceptor of claim 12, wherein the mortises of the first interlocking member have a width and the tenons of the second interlocking member have a width, and wherein the width of the mortises of the first interlocking member is greater than or equal to the width of the tenons of the second interlocking member.

15. The susceptor of claim 12, wherein the tenons of the first interlocking member are received within the mortises of the second interlocking member when the first wall and second wall are interlocked in the assembled configuration.

16. A susceptor for supporting a crucible in a directional solidification furnace used to melt a semiconductor material, the susceptor comprising:
a first wall having a vertical edge and an interior surface;
a second wall having a vertical edge and an interior surface, wherein when in an assembled configuration the vertical edge of the first wall is positioned adjacent a portion of the interior surface of the second wall; and
a separator positioned between the vertical edge of the first wall and the portion of the interior surface of the second wall, wherein the separator prevents contact between the vertical edge of the first wall and the portion of the interior surface of the second wall when the walls are in the assembled configuration.

17. The susceptor of claim 16, wherein the separator comprises a fabric of compressed fibers.

18. The susceptor of claim 17, wherein the fabric of compressed fibers includes felt.

19. The susceptor of claim 16, wherein the separator prevents the vertical edge of the first wall from bonding to the portion of the interior surface of the second wall.
